(19) United States
(12) Patent Application Publication
(10) Pub. No.: US 2005/0280822 A1
(43) Pub. Date: Dec. 22, 2005

(54) Inspecting apparatus and inspecting method for color filters

(75) Inventor: Jian-Qiu Zeng, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/156,066

(22) Filed: Jun. 17, 2005

(30) Foreign Application Priority Data
Jun. 18, 2004 (TW) 93117703

(51) Int. Cl. G01J 3/46

(52) U.S. Cl. 356/402

(57) ABSTRACT

An inspecting apparatus for a color filter having a plurality of red, green, and blue sub-pixels is disclosed. The inspecting apparatus includes a carrying stage (20, 30) for supporting the color filter, a light source (21, 31) arranged under the carrying stage, a grating (25, 35) arranged over the carrying stage. The grating has a substrate (251, 351) and a plurality of grid lines (252, 352) arranged in the substrate, and an optical inspecting device (24, 34) arranged above the grating and the carrying stage. The cost of the inspecting apparatus is lower than that of a typical inspecting apparatus. An inspecting method for a color filter using the inspecting apparatus is also provided. The inspecting method using the inspecting apparatus is faster than an inspecting method using a typical inspecting apparatus.

### FIELD OF THE INVENTION

The present invention relates to an inspecting apparatus and a method for inspecting color filters, and more particularly to an inspecting apparatus and a method for inspecting the chroma of color filters.

### BACKGROUND

Liquid crystal displays (LCDs) utilize a color filter to display color images. The performance of the color filter directly affects the quality of the color images displayed. Thus, it is very important to inspect the color filter in order to verify its quality.

FIG. 17 shows a typical inspecting apparatus for color filters. The inspecting apparatus includes a carrying stage 10, a light source 11, an optical controlling device 13, and an optical inspecting device 14. The carrying stage 10 is made of transparent material. The light source 11 is arranged under the carrying stage 10, and emits white light. The optical controlling device 13 is a liquid crystal cell, and is arranged on the carrying stage 10. The optical inspecting device 14 is arranged above the optical controlling device 13. A color filter 12 to be inspected is arranged on the optical controlling device 13. During inspection, driving signals are applied to the optical controlling device 13 to control light emitted by the light source 11 in order to illuminate a certain portion of the color filter 12.

Referring to FIG. 18, the color filter 12 includes a plurality of red (R), green (G), and blue (B) sub-pixels. The red, green, and blue sub-pixels are alternately arranged in a first direction, and the sub-pixels of a same color are continuously arranged in a second direction perpendicular to the first direction. If the optical controlling device 13 is not utilized, all of white light emitted by the light source 11 directly reaches to the color filter 12. Accordingly, light output from the color filter 12 is white light. Thus, when the color filter 12 is viewed through the optical inspecting device 14, one can only view red, green, and blue sub-pixels simultaneously. As shown in FIG. 19, it is not possible to inspect a single chroma of the color filter 12. Therefore, if using the typical inspecting apparatus to inspect the individual chroma of the red, green, and blue sub-pixels of the color filter 12. The upshot is that it is necessary to utilize the optical controlling device 13 to control the emitted light and view a sample of a single color.

For example, when the light source 11 is turned on, a driving signal is applied, and the optical controlling device 13 controls light emitted from the light source 11 so that only red sub-pixels can receive the light. Thus the color filter 12 displays red, and red sub-pixels of the color filter 12 can be viewed using the optical inspecting device 14, as shown in FIG. 20. That is, the saturation of the red sub-pixels of the color filter 12 can be inspected. Similarly, the green saturation of green sub-pixels and the saturation of blue sub-pixels of the color filter 12 can be inspected.

In sum, it is necessary to use the optical controlling device 13 when utilizing the typical inspecting apparatus to inspect the chroma of color sub-pixels of the color filter 12. The need to apply driving signals adds to the total inspection time. Nevertheless, the optical controlling device 13 is needed for high precision inspections. But it is not desired that the optical controlling device 13 having a high precision is very expensive.

What is needed, therefore, is an inspecting apparatus for color filters which provides fast inspection in order to improve efficiency and reduce costs.

### SUMMARY

In a preferred embodiment, an inspecting apparatus of a color filter having a plurality of red, green, and blue sub-pixels, the inspecting apparatus comprises a carrying stage for supporting the color filter, a light source arranged under the carrying stage, a grating arranged over the carrying stage. The grating includes a substrate and a plurality of grid lines arranged in the substrate, and an optical inspecting device arranged above the grating.

In another embodiment, an method for inspecting a color filter having a plurality of red, green, and blue sub-pixels, the method includes the following steps: arranging a grating having a plurality of grid lines over a carrying stage; arranging a color filter on the carrying stage; utilizing a light source under the carrying stage to illuminate the color filter; and utilizing an optical inspecting device above the grating to view the chroma of one or mor selected of the red, green, and blue sub-pixels.

Because the grating has a plurality of grid lines, when the light source is turned on, the grating is arranged corresponding to a color filter to be inspected, and then, the color filter has some areas of the color filter displaying single color images. Unlike a typical inspecting method using a typical inspecting apparatus, the inspecting method using the grating can provide inspection of the chroma of the color filter without the need for driving signals to be applied. Therefore, the inspecting method using the grating is faster than the typical inspecting method using the typical inspecting apparatus.

Further, the inspecting apparatus utilizes the grating instead of a conventional optical inspecting apparatus of the typical inspecting apparatus. In general, the cost of the grating is considerably lower than that of the optical inspecting device. Thus, the inspecting apparatus using the grating is inexpensive compared with the typical inspecting apparatus.

Other advantages and novel features will become more apparent from the following detailed description when taken in conjunction with the accompanying drawings, in which:

### BRIEF DESCRIPTION OF THE DRAWINGS

FIG. 1 is a schematic side view of an inspecting apparatus according to a first embodiment of the present invention, together with a color filter under inspection;

FIG. 2 is a simplified top view of a grating of the inspecting apparatus of FIG. 1;

FIG. 3 is a simplified top view of a color filter, in which a plurality of sub-pixels is arranged in a regular, repeating mosaic;

FIG. 4 is a simplified top view of a color filter, in which a plurality of sub-pixels is arranged in a matrix defining long stripes;

FIG. 5 is a simplified top view of a color filter, in which a plurality of sub-pixels is arranged in a regular array of long continuous stripes;

FIG. 6 is a top view of the grating of FIG. 2 arranged over the color filter of FIG. 5, such that grid lines of the grating are parallel to the stripes of the color filter, and showing a field of view of an optical inspecting device of the inspecting apparatus of FIG. 1;

FIG. 7 is an enlargement of the field of view of FIG. 6;

FIG. 8 is similar to FIG. 6, but showing the grating arranged such that the grid lines of the grating obliquely cross the stripes of the color filter;

FIG. 9 is an enlargement of a field of view of FIG. 8;

FIG. 10 is a schematic side view of an inspecting apparatus according to a second embodiment of the present invention, together with a color filter under inspection;

FIG. 11 is a simplified top view of a grating of the inspecting apparatus of FIG. 10;

FIG. 12 is a top view of the grating of FIG. 11 arranged over the color filter of FIG. 5, such that grid lines of the grating are parallel to the stripes of the color filter, and showing a field of view of an optical inspecting device of the inspecting apparatus of FIG. 10;

FIG. 13 is an enlargement of the field of view of FIG. 12;

FIG. 14 is similar to FIG. 12, but showing the grating arranged such that the grid lines of the grating obliquely cross the stripes of the color filter;

FIG. 15 is an enlargement of a field of view of FIG. 14;

FIG. 16 is a schematic side view of an inspecting apparatus according to another embodiment of the present invention, together with a liquid crystal display panel under inspection;

FIG. 17 is a schematic side view of a typical inspecting apparatus together with a color filter under inspection, the inspecting apparatus comprising an optical inspecting device and an optical controlling device;

FIG. 18 is a simplified top view of the color filter of FIG. 17, the color filter having a plurality of sub-pixels arranged in a matrix defining long stripes;

FIG. 19 represents a field of view of the color filter of FIG. 18, as seen through the optical inspecting device of FIG. 17 when no driving signals are applied to the optical controlling device; and

FIG. 20 is similar to FIG. 19, but showing the field of view when driving signals are applied to the optical controlling device.

### DETAILED DESCRIPTION OF PREFERRED EMBODIMENTS

Referring to FIG. 1, this shows an inspecting apparatus for a color filter according to a first embodiment of the present invention, together with a color filter under inspection. The inspecting apparatus includes a carrying stage 20, a light source 21, an optical inspecting device 24, and a grating 25. The light source 21 is arranged under the carrying stage 20. The grating 25 is arranged over the carrying stage 20. The optical inspecting device 24 is arranged above the carrying stage 20 and the grating 25. The carrying stage 20 is made of glass. The light source 21 is a cold cathode fluorescent lamp (CCFL) that emits white light.

The optical inspecting device 24 is a color brightness meter, which is utilized to measure brightness and chroma. The color brightness meter is generally a BM-7 type, a BM-5 type, etc. For example, a BM-7 type color brightness meter includes a chroma detector, a flush type singlechip, a liquid crystal display, a battery, and so on.

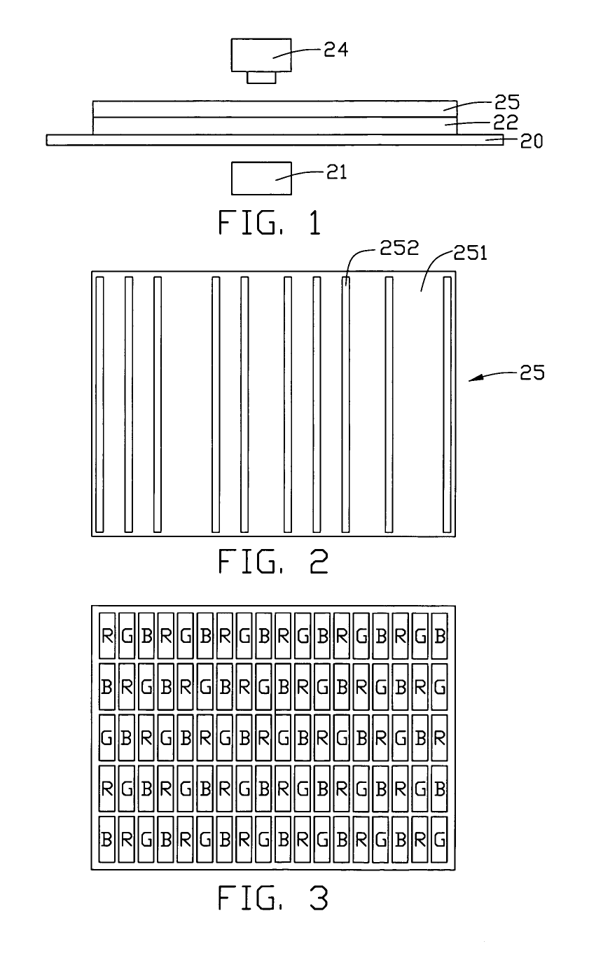

Referring to FIG. 2, the grating 25 includes a substrate 251 and a plurality of parallel grid lines 252 arranged in the substrate 251. The substrate 251 is made of nontransparent material such as aluminum. Alternatively, the substrate 251 may be made of another kind of nontransparent metal or a nontransparent organic material. When an inspection is carried out, a color filter 22 is arranged between the carrying stage 20 and the grating 25. The color filter 22 includes a plurality of red, green, and blue sub-pixels. The parallel grid lines 252 are narrow gaps. A width of each of the grid lines 252 is less than a width of each of the red, green, and blue sub-pixels.

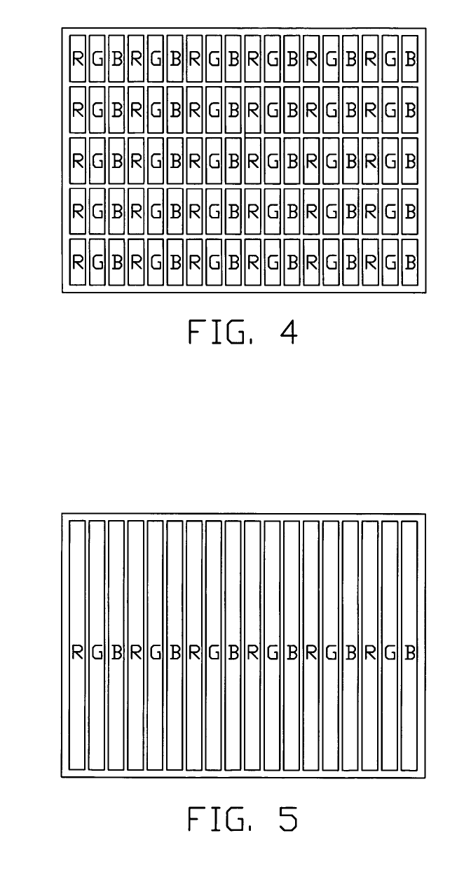

The red, green, and blue sub-pixels of the color filter 22 may be arranged in a regular, repeating mosaic (see FIG. 3), a matrix defining long stripes (see FIG. 4), or a regular array of long continuous stripes (see FIG. 5). Even though the red, green, and blue sub-pixels may have, for example, any of the three above-described different distributions, the respective methods for inspecting the corresponding color filters 22 are similar or the same. An inspection method for a color filter 22 is described below. In the description, it is assumed that the color filter 22 has the red, green, and blue sub-pixels arranged in a regular array of long continuous stripes.

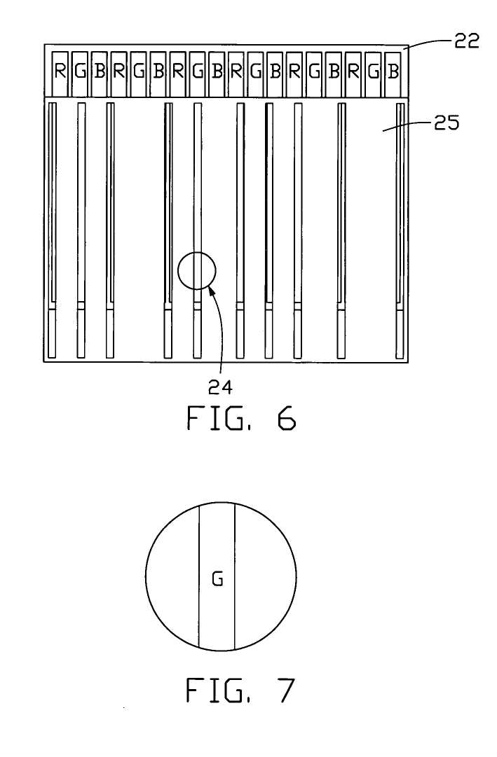

Referring to FIG. 6, during inspection, the grid lines 252 are oriented parallel to the sub-pixels, and at least some of the grid lines 252 are located over sub-pixels having the same color. When the light source 21 is turned on, the color filter 22 has some rectangular areas displaying single color images. Referring to FIG. 7, a sub-pixel is viewed through a corresponding grid 252 using the optical inspecting device 24. In this way, inspection of the chroma of the color filter 22 is achieved.

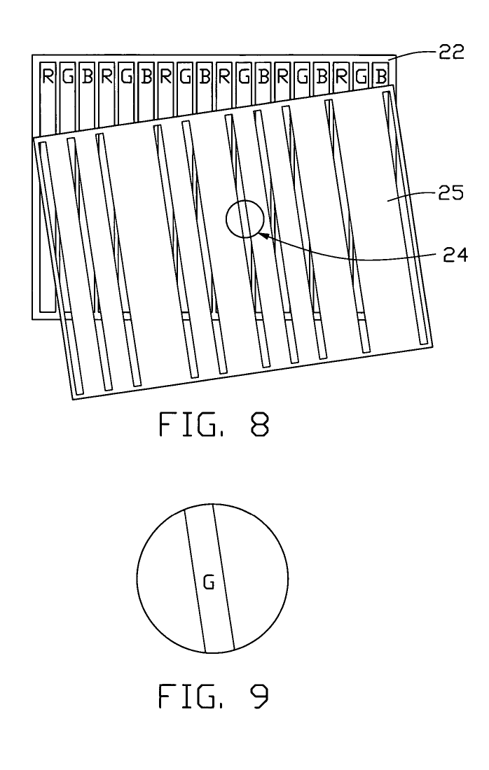

Referring to FIG. 8, during inspection, the grid lines 252 may cross the sub-pixels obliquely. When the light source 21 is turned on, the color filter 22 has some parallelogram-shaped areas displaying single color images. Sizes of the parallelogram-shaped areas may be controlled by adjusting a crossing angle between the grid lines 252 and the sub-pixels. Referring to FIG. 9, a sub-pixel is viewed through a corresponding grid 252 using the optical inspecting device 24. In this way, inspection of the chroma of the color filter 22 is also achieved. Referring to FIG. 10, this shows an inspecting apparatus for a color filter according to a second embodiment of the present invention, together with a color filter under inspection. The inspecting apparatus includes a carrying stage 30, a light source 31, an optical inspecting device 34, and a grating 35. The light source 31 is arranged under the carrying stage 30. The grating 35 is arranged over the carrying stage 30. The optical inspecting device 34 is arranged above the carrying stage 30 and the grating 35. The carrying stage 30 may be made of nontransparent or transparent material. The carrying stage 30 has a plurality of through holes 301, which allow transmission of light from the light source 31 therethrough. The light source 31 is a light emitting diode (LED) that emits white light. The optical inspecting device 34 is a color brightness meter, which is utilized to measure brightness and chroma.

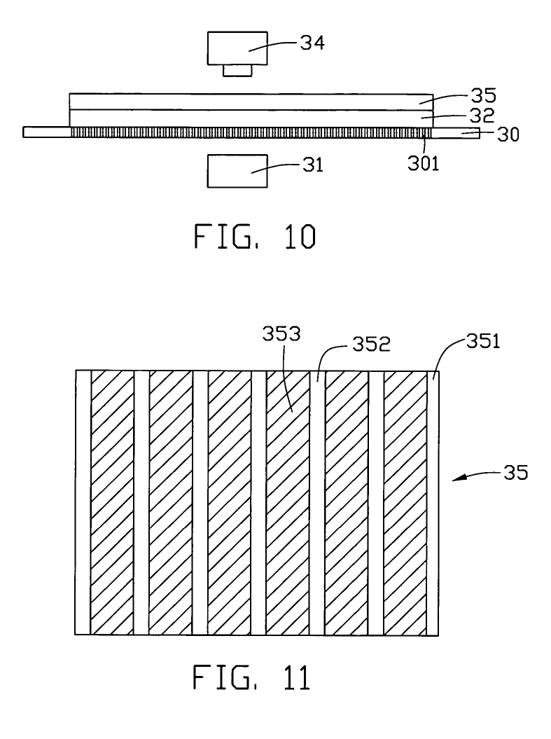

Referring to FIG. 11, the grating 35 includes a substrate 351 and a plurality of parallel grid lines 352 arranged in the substrate 351. The substrate 351 is made of transparent material such as glass. The substrate 351 is coated with black photo-resist 353 except at the grid lines 352, therefore light can only pass through the grid lines 352. During inspection, a color filter 32 is arranged between the carrying stage 30 and the grating 35. The color filter 32 includes a plurality of red, green, and blue sub-pixels. A width of each of the parallel grid lines 352 is the same as a width of each of the red, green, and blue sub-pixels. A width of each striped portion of black photo-resist 353 is twice the width of each of the red, green, and blue sub-pixels.

The grating 35 may be produced by the following steps. Firstly, utilizing a drawing software program (such as AutoCAD, etc) installed in a personal computer to design a pattern of photo-resist portions. Then, utilizing a slide film to print the grating 35 by way of a printer.

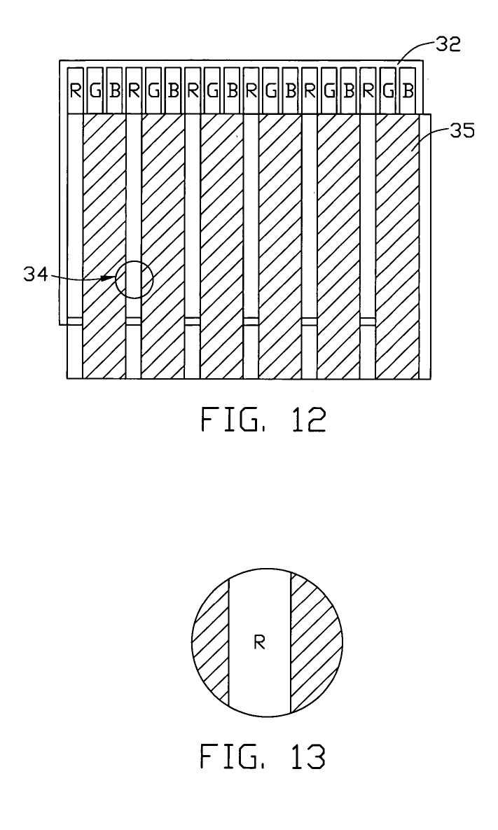

In this embodiment, it is again assumed that the red, green, and blue sub-pixels of the color filter 32 are arranged in a regular array of long continuous stripes. Referring to FIG. 12, the grid lines 352 overlap sub-pixels having the same color. Because the width of each striped portion of black photo-resist 353 is twice the width of each sub-pixels, the grid lines 352 precisely overlap the same-colored sub-pixels. Referring to FIG. 13, when the light source 31 is turned on, a sub-pixel is viewed through a corresponding grid 352 using the optical inspecting device 34. In this way, inspection of the chroma of the color filter 32 is achieved.

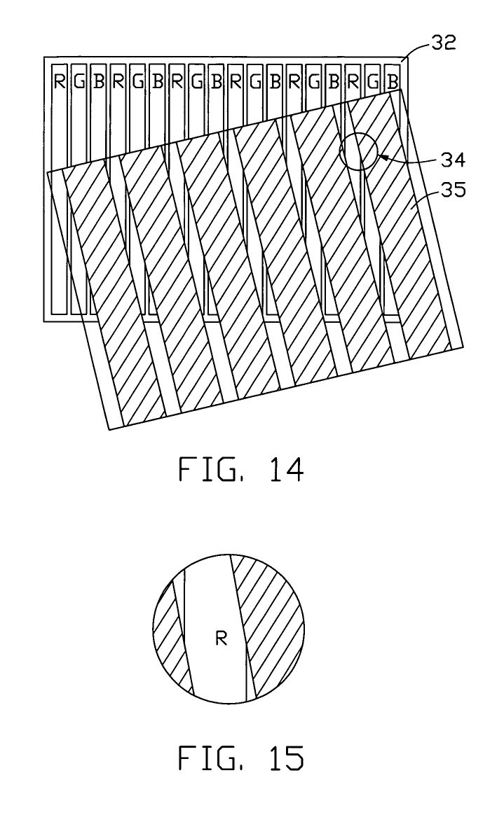

Referring to FIG. 14, during inspection, the grid lines 352 may cross the sub-pixels obliquely. When the light source 31 is turned on, the color filter 32 has some rhombic areas displaying single color images. Sizes of the rhombic areas may be controlled by adjusting a crossing angle between the grid lines 352 and the sub-pixels. Referring to FIG. 15, a sub-pixel is viewed through a corresponding grid 352 using the optical inspecting device 34. In this way, inspection of the chroma of the color filter 32 is also achieved.

In addition, when the grid lines 352 cross the sub-pixels obliquely, if high precision inspection is not required, the inspection may be performed with the naked eye instead of with the optical inspecting device 34.

In the first and second embodiments, because the gratings 25, 35 have the plurality of grid lines 252, 352, when the light sources 21, 31 are turned on, the gratings 25, 35 are oriented corresponding to a color filter 22 to be inspected. Accordingly, some areas of the color filter 22 display a single color image. Unlike a typical inspecting method using a typical inspecting apparatus, the inspecting method using the grating 25 or 35 can provide inspection of the chroma of the color filter 22 without the need for driving signals to be applied. Therefore, the inspecting method using the grating 25 or 35 is faster than the typical inspecting method using the typical inspecting apparatus.

Further, the inspecting apparatus of the described embodiments utilizes the grating 25 or 35 instead of a conventional optical inspecting device of the typical inspecting apparatus. In general, the cost of the grating 25 or 35 is considerably lower than that of the optical inspecting device. Thus, the inspecting apparatus using the grating 25 or 35 is inexpensive compared with the typical inspecting apparatus.

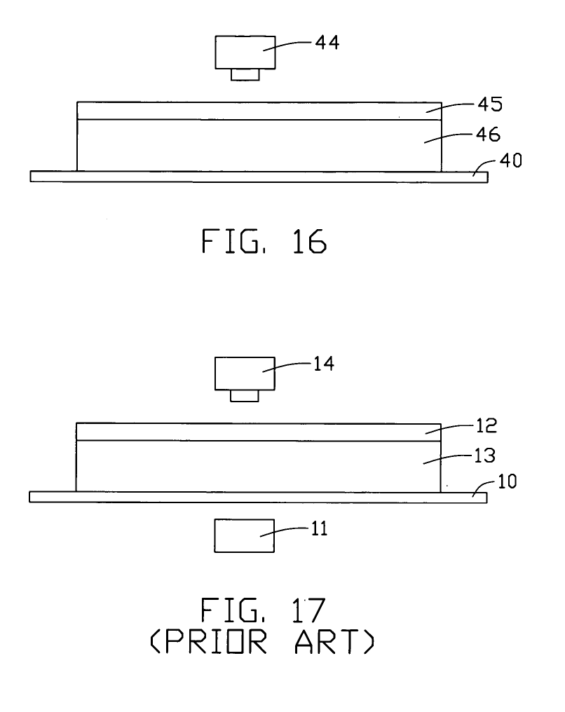

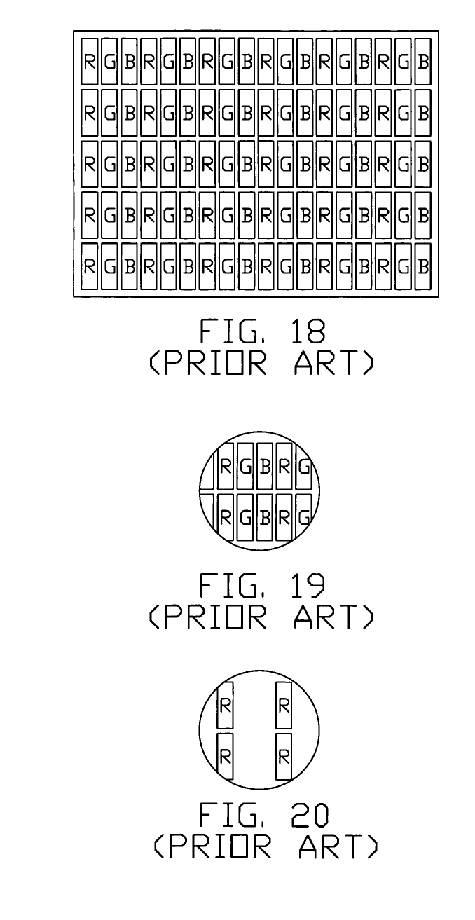

Referring to FIG. 16, this shows an inspecting apparatus for a liquid crystal display panel according to another embodiment of the present invention, together with a liquid crystal display panel under inspection. The inspecting apparatus includes a carrying stage 40, a grating 45, and an optical inspecting device 44. A liquid crystal display panel 46 includes a color filter (not shown), and a backlight source (not shown) arranged under the color filter. A method for inspecting the chroma of the liquid crystal display panel 46 is substantially similar to the above-described inspecting methods regarding color filters. The main difference is that the backlight source is turned on, without the need for the inspecting apparatus to have its own light source. Thus inspection of the chroma of the liquid crystal display panel 46 can be readily achieved.

In addition, the inventive inspecting apparatus is not limited to the above-described embodiments. For example, the light sources 21, 31 may be other kinds of light sources that emit white light. The optical inspecting devices 24, 34 may be microscopes.

It is to be further understood that even though numerous characteristics and advantages of embodiments have been set forth in the foregoing description, together with details of the structures and functions of the embodiments, the disclosure is illustrative only, and changes may be made in detail to the full extent indicated by the broad general meaning of the terms in which the appended claims are expressed.

1. An inspecting apparatus of a color filter having a plurality of red, green, and blue sub-pixels, the inspecting apparatus comprising:
a carrying stage for supporting the color filter;
a light source arranged under the carrying stage;
a grating arranged over the carrying stage, the grating comprising a substrate and a plurality of grid lines arranged in the substrate; and
an optical inspecting device arranged above the grating.

2. The inspecting apparatus of claim 1, wherein the grid lines can be oriented to be parallel with the red, green, and blue sub-pixels.

3. The inspecting apparatus of claim 1, wherein the grid lines can be oriented to obliquely cross the red, green, and blue sub-pixels.

4. The inspecting apparatus of claim 1, wherein the substrate is made of nontransparent material, and the grid lines are narrow gaps.

5. The inspecting apparatus of claim 4, wherein the substrate is made of aluminum.

6. The inspecting apparatus of claim 1, wherein the substrate is made of transparent material, and is coated with black photo-resist except at the grid lines.

7. The inspecting apparatus of claim 6, wherein the substrate is made of glass.

8. The inspecting apparatus of claim 6, wherein a width of each of portions of the substrate coated with black photo-resist is twice a width of each of the red, green, and blue sub-pixels.

9. The inspecting apparatus of claim 1, wherein a width of each of the grid lines is less than a width of each of the red, green, and blue sub-pixels.

10. The inspecting apparatus of claim 1, wherein a width of each of the grid lines is the same as a width of each of the red, green, and blue sub-pixels.

11. The inspecting apparatus of claim 1, wherein the carrying stage is made of transparent material.

12. The inspecting apparatus of claim 11, wherein the carrying stage is made of glass.

13. The inspecting apparatus of claim 1, wherein the carrying stage defines a plurality of through holes.

14. A method for inspecting a color filter having a plurality of red, green, and blue sub-pixels, the method comprising:
arranging a grating having a plurality of grid lines over a carrying stage;
arranging a color filter on the carrying stage;
utilizing a light source under the carrying stage to illuminate the color filter; and
utilizing an optical inspecting device above the grating to view the chroma of one or more selected of the red, green, and blue sub-pixels.

15. The method of claim 14, further comprising arranging the grid lines to be parallel with at least some of the red, green, and blue sub-pixels, whereby the grid lines overlap sub-pixels having a same color.

16. An assembly comprising:
a color filter essentially consisting of red, green and blue sub-pixels each defining a first longitudinal direction and a first transverse direction perpendicular to said first longitudinal direction;
a grating located on one side of the color filter and comprising a substrate with therein a plurality of parallel grid lines each defining a second longitudinal direction and a second transverse direction perpendicular to said second longitudinal direction;
a light source positioned on an opposite side of the color filter; and
an inspect device located on one side of the grating opposite to said color filter.

17. The assembly as claimed in claim 16, wherein said first longitudinal direction and said second longitudinal direction are parallel to each other, and said first transverse direction and said second transverse direction are parallel to each other.

18. The assembly as claimed in claim 16, wherein a dimension of the sub-pixel in the first transverse direction is smaller than that of the grid line in the second transverse direction.

19. The assembly as claimed in claim 16, wherein said first longitudinal direction and said second longitudinal direction are oblique to each other, and said first transverse direction and said second transverse direction are oblique to each other.
